(19) United States
(12) Patent Application Publication
(10) Pub. No.: US 2004/0079009 A1
(43) Pub. Date: Apr. 29, 2004

(54) License mounting plate

(76) Inventor: Marcel G. Arrua, Norwalk, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/614,679

(22) Filed: Jul. 3, 2003

Related U.S. Application Data
(60) Provisional application No. 60/393,793, filed on Jul. 3, 2002.

(51) Int. Cl. G09F 13/02

(52) U.S. Cl. 40/204

(57) ABSTRACT

Generally, in one embodiment, a license mounting plate, configured for adapting to a vehicle, comprises a mounting member, a license holding member and holding members. The mounting member is designed to attach to a rear of a vehicle. The license holding member is designed to hold a license plate. The holding members are adapted to securely support a pair of turn signals.

### CROSS-REFERENCE

This application claims the benefit of priority on a U.S. Provisional Application No. 60/393,793 filed Jul. 3, 2002.

### FIELD

The invention relates to a mechanism for retention of a license plate to a vehicle, and in particular, a license mounting plate for a motorcycle.

### BACKGROUND

Generally, a license plate of a motorcycle is positioned under the tail lamp and fixedly secured by a bracket attached a rear fender of a motorcycle. This position permits easy visual observation of the license plate during normal use. However, when riding a motorcycle under race track condition, the license plate must be removed in order to mitigate the chances of dangerous debris falling on the track. Normally, this requires the user to remove the tail light and turn signals and, in some cases, the rear fender. This poses a number of disadvantages.

One disadvantage is that the removal of these components is that it takes a considerable amount of time and effort. Also, when the rear fender is not removed, the motorcycle will experience increased drag. This results in decreased performance of the motorcycle and increased instability. The later result poses additional dangers to the rider.

Also, it is appreciated that the next generation of motorcycles are featuring enclosed tail sections that provide a cleaner, racier look. These next generation motorcycles have a removable fender, which is not integrated to the under carriage fender found in most motorcycles.

### BRIEF DESCRIPTION OF THE DRAWINGS

The features and advantages of embodiments of the invention will become apparent from the following detailed description of the invention in which:

FIG. 1 is an exemplary embodiment of a motorcycle utilizing an embodiment of the license mounting plate.

FIG. 2 is a perspective view of an illustrative embodiment of the license mounting plate.

FIG. 3 is a side view of the license mounting plate of FIG. 2.

FIG. 4 is a top view of the footprint of the license mounting plate prior to angular adjustment of the license holding member and the signal holding members.

FIG. 5 is an exemplary embodiment of the flow chart describing the operations followed to attach the license mounting plate to a motorcycle.

FIG. 6 is a secondary embodiment of the license mounting plate.

FIG. 7 is another embodiment of the license mounting plate.

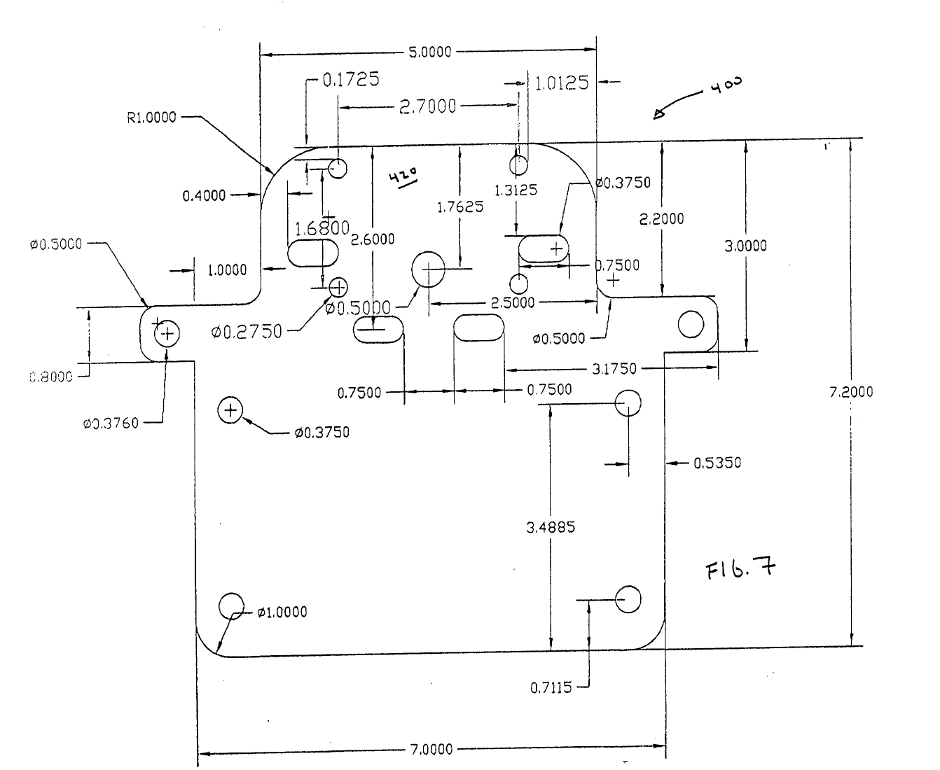

### DETAILED DESCRIPTION

In general, various embodiments of the invention describe a mechanism for securing a license plate and turn signals for a vehicle. This mechanism, a license mounting plate in one embodiment, is configured for installation on a number of different vehicles produced by different manufacturers and for quick removal prior to on-track use.

Certain terminology is used to describe certain features of the invention. For example, an “aperture” is an opening (or hole) pre-drilled during manufacture or made at the time of installation. A “vehicle” is any motorized, two-wheeled transportation device such as, for example, a motorcycle, moped or even a scooter.

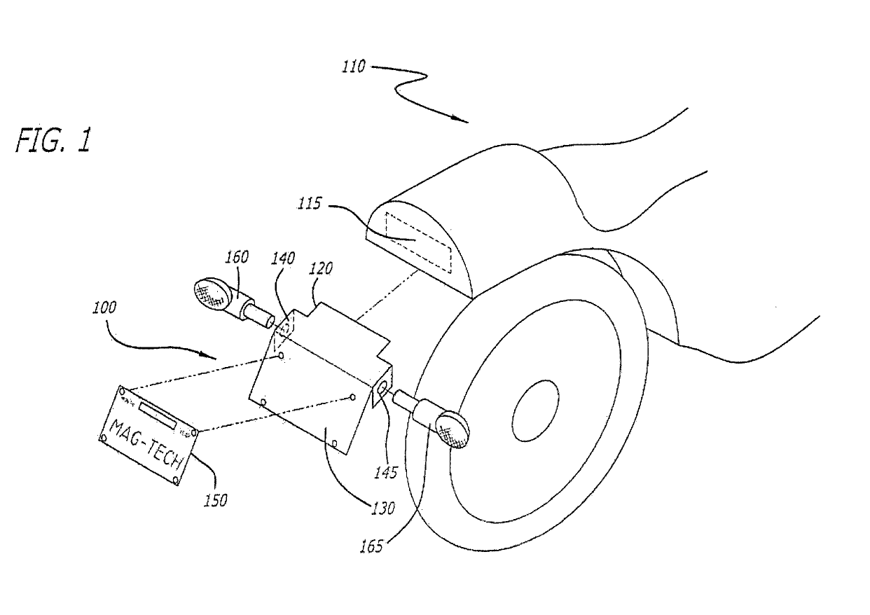

Referring now to FIG. 1, an exemplary embodiment of a license mounting plate 100 being adapted to a vehicle 110 is shown. License mounting plate 100 comprises a mounting member 120, a license holding member 130 and signal holding members 140 and 145. For one embodiment, license mounting plate 100 is made of a rust resistant, light-weight metal (e.g., powder coated aluminum). Thus, only a small amount of weight (e.g., approximately 5 ounces) is added to the vehicle.

As shown in FIG. 1, mounting member 120 is positioned under a tail lamp 115 of vehicle 110 so that light from tail lamp 115 illuminates a license plate 150 placed on license holding member 130. License holding member 130 is angularly positioned from a plane containing the mounting member 120. This enables visual observation of the license plate 150. The signal holding members 140 and 145 are adapted to receive and support turn signals 160 and 165, respectively.

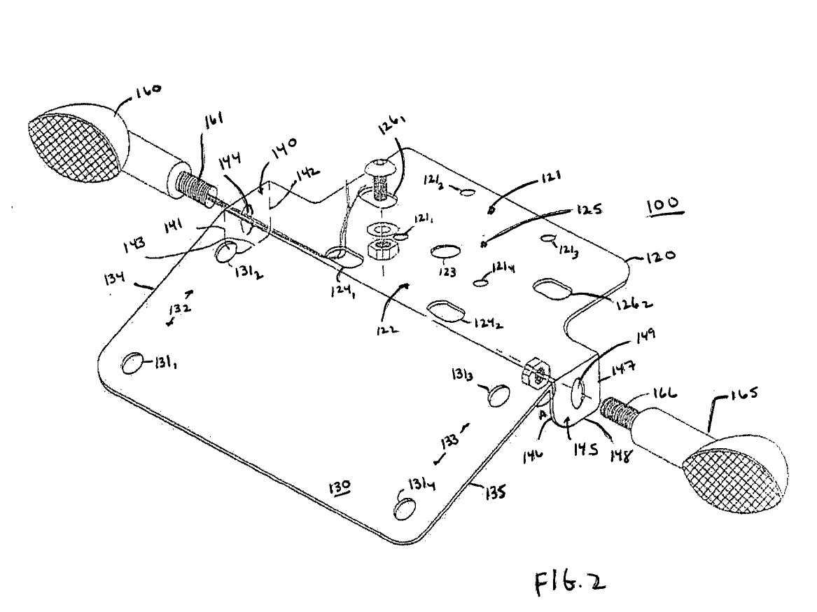

Referring now to FIG. 2, a perspective view of an exemplary embodiment of the license mounting plate 100 of FIG. 1 is shown. License mounting plate 100 includes mounting member 120, license holding member 130, and signal holding members 140 and 145. License holding member 130 is positioned at an angle “A” from a plane containing mounting member 120. The selected degrees of rotation for angle A is greater than ninety (90) degrees but less than one-hundred eighty (180) degrees, normally ranging between approximately 115 degrees to approximately 155 degrees. Signal holding members 140 and 145, for this embodiment, are generally perpendicular to a plane containing mounting member 120 and are substantially in parallel with each other.

As shown, license holding member 130 includes a plurality of apertures 131₁-131_{N} (where N≧2). For this embodiment of the invention, a first aperture set 132 is placed generally proximate to a first edge 134 of license holding member 130. A second aperture set 133 is placed generally proximate to a second edge 135 of license holding member 130. The second edge 135 being on an opposite side of license holding member 130.

The apertures 131₁-131_{N} are sized to receive a removable, securing member (not shown) to secure the license plate to license holding member 130. Normally, the securing member includes a bolt and a fastener (e.g., nut, lock nut) but may include other mechanisms such as a grommet or even a rivet (if quick removal is not desired).

Referring still to FIG. 2, for this embodiment of the invention, mounting member 120 includes three groupings of apertures 121, 122 and 125. A first grouping of apertures 121 (121₁-121₄) is designed for R-1 applications for attachment to certain types of vehicles such as 2002 versions of YAMAHA® 1000cc motorcycle series.

A second grouping 122 comprises a plurality of apertures including center aperture 123 and at least two apertures 124₁ and 124₂, which are collectively positioned in a triangular manner. The second grouping 122 is designed for R-6 applications for attachment to other types of vehicles such as 2001 versions of YAMAHA® 600cc motorcycle series. The plate 100 is secured to a vehicle (not shown) by securing members such as ⅜″ Allen bolt and ⅜″ lock nuts in this embodiment. Wiring from the turn signals 160 and 165 may be placed through center aperture 123, which is used as a through-hole.

A third grouping of apertures 125 comprises a plurality of apertures including center aperture 123 and at least two apertures 126₁ and 126₂. Apertures 123, 126₁ and 126₂ are generally aligned. The third grouping 125 is designed for a wide variety of SUZUKI® and KAWASAKI® motorcycles.

Once adjusted to be generally parallel with the plane containing mounting member 120 by manufacturer of the end user, signal holding members 140 and 145 are configured with edges 141, 142 and 146, 147 that are generally equivalent in length with edges 143 and 148, respectively. Apertures 144 and 149 are sized to accommodate attachment bolts 161 and 166 associated with turn signals 160 and 165, respectively. As shown for this embodiment, the sizing of apertures 144 and 149 is approximately 0.4″ in diameter but other diameter sizes may be utilized.

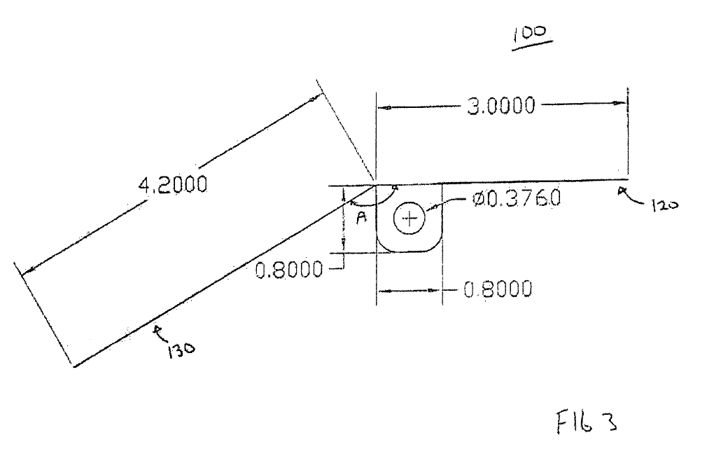

Referring now to FIG. 3, a side view of the exemplary embodiment of license mounting plate 100 is shown. For this embodiment of the invention, a partial portion of mounting member 120 is constructed with a width less than the width of license holding member 130. Herein, the widths of mounting member 120 and license holding member 130 are approximately 3.0 inches and 4.2 inches, respectively. Of course, other widths may be used. The angular adjustment “A” between license holding member 130 and mounting member 120 is shown to be approximately 135 degrees.

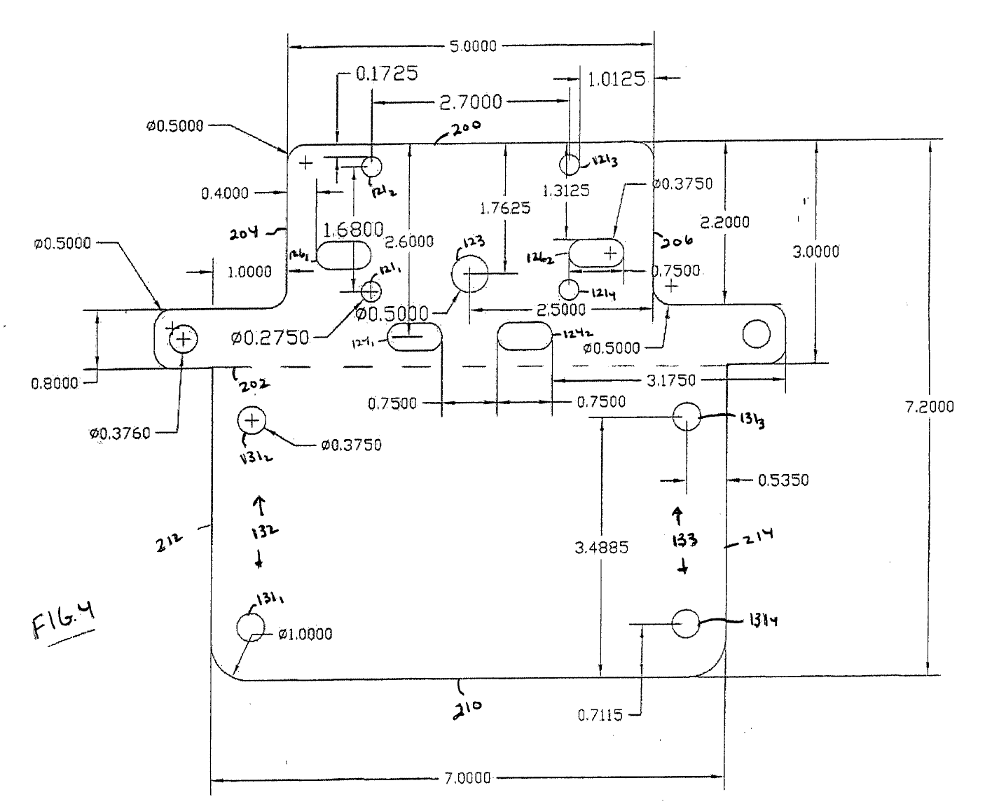

Referring now to FIG. 4, an exemplary embodiment of a footprint of license mounting plate 100 prior to angular adjustment of license holding member 130 and signal holding members 140 and 145 is shown.

As shown, mounting member 120 is generally sized to be approximately 3 inches in width with a length of approximately 5-inches at a first edge 200 and 7-inches at a second edge 202. The first grouping of apertures 121 includes a first set of apertures 121₁, 121₂ and a second set of apertures 1213, 1214. The first set of apertures 121₁, 121₂ are aligned to be generally parallel with third edge 204 and are separated by a distance of approximately 1.7 inches. Also, apertures 121₃, 121₄ are separated by approximately 1.7 inches and are generally in parallel with a fourth edge 206. The distance of separation between apertures 121₁, 121₂ and apertures 121₃, 121₄ is approximately 2.7 inches.

The center apertures 123 from second grouping 122 is placed approximately 2.5 inches from fourth edge 206 of mounting member 120 and approximately 1.8 inches from the first edge 200 of mounting member 120. Apertures 124₁ and 124₂ are oblong shaped and placed approximately 2.6″ from edge 200 and generally equidistant from center aperture 123.

Apertures from third grouping 125 include center aperture 123 and oblong-shaped apertures 126₁ and 126₂, which are positioned approximately 0.4″ from edges 204 and 206, respectively, and closer to first edge 200 of mounting member 120 than apertures 121₂ and 121₄. For this embodiment, the sizing of apertures 124₁-124₂ and 126₁-126₂ is a width of approximately 0.4″ and a length of approximately 0.75″.

Plate holder member 130 features apertures 131₁ and 131₄ positioned approximately 0.7″ from a first edge 210 of license holding member 130 while apertures 131₂ and 131₃ are positioned approximately 3.5″ from first edge 210. The first aperture set 132 (apertures 131₁ and 131₂) of license holding member 130 are positioned less than 1″ from a second edge 212 of license holding member 130. Likewise, the second aperture set 133 (apertures 131₃ and 131₄) are positioned less than 1″ from a third edge 214 of license holding member 130. The sizing of the apertures is designed with at least a ⅜″ diameter, but may be adjusted to any sizing desired.

The signal holding members 140 and 145 protrude from edges 212, 214 defining license holding member 130. These members 140 and 145 are angularly adjusted to be contained within a plane formed by edges 212 and 214, respectively.

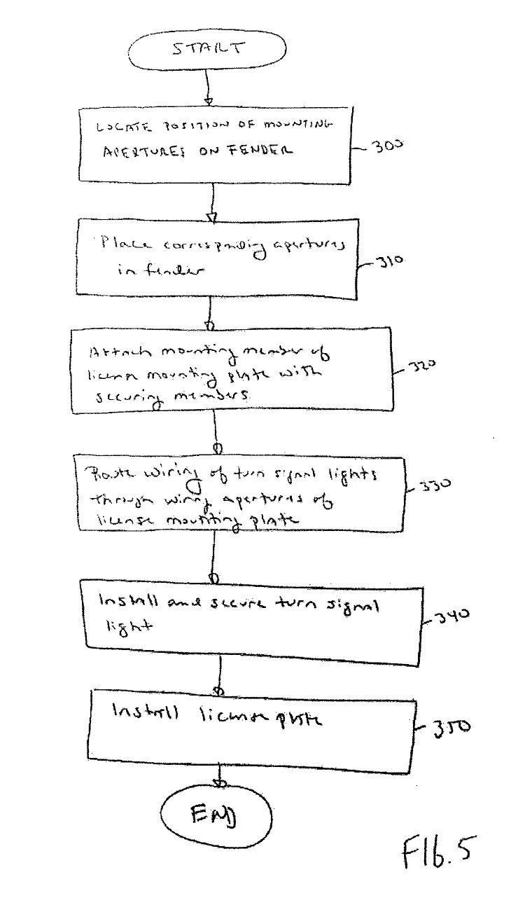

Referring to FIG. 5, an illustrative embodiment of a flowchart describing operations for mounting the license mounting plate to a vehicle is shown. Initially, hardware from the original equipment manufacturer (OEM) is removed. For example, multiple allen bolts and barrel washers are removed on 2002 R1 and 2001/2002 R6 motorcycles, and repositioned to fasten the license mounting plate.

Then, the mounting member of the license mounting plate is positioned under a tail lamp of a vehicle and the locations of the appropriate mounting apertures are denoted on the rear fender (block 300). Thereafter, electrical wiring is cleared from locations under the rear fender associated with the mounting apertures and corresponding apertures are drilled into the rear fender (block 310).

Next, securing members, such as mounting bolts for example, are inserted from top of the rear fender and fastened under the mounting member (block 320). For R6 (01-02) and R1 (01-02) motorcycle types, oblong apertures or center aperture is used for appropriately routing the wiring of the turn signal lights (block 330).

After the wiring has be completed, turn signals are installed by insertion through apertures of the signal holding members (block 340). A license plate is installed by attaching the license plate using plate apertures 131₁-131₄ of the license holding member 130 (block 350).

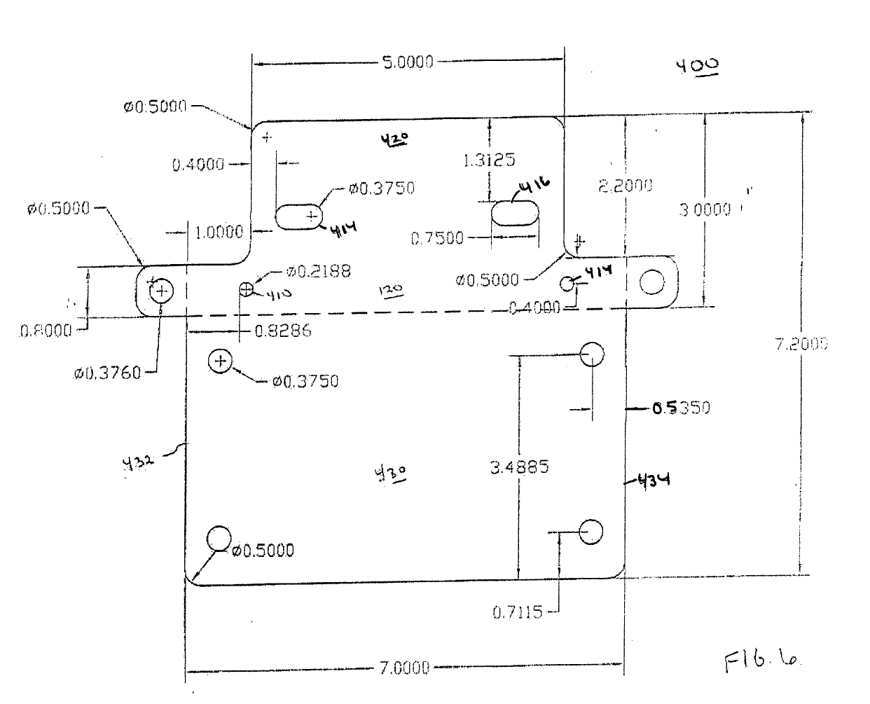

Referring now to FIG. 6, secondary embodiments of the license mounting plate 400 have been contemplated without universal application. For instance, only one or perhaps two of the aperture groupings 121, 122 and 125 of FIG. 2 may be incorporated into the license mounting plate. Alternatively, other embodiments may be formulated.

For example, as shown in FIG. 6, license mounting plate 400 may include different orientation of apertures within mounting member 420. In particular, mounting member 420 includes a set of wiring apertures 410 and 412. Apertures 410 and 412 are positioned approximately 1″ from edges 432 and 434 of license holding member 430. The diameter sizing of apertures 410 and 412 are substantially less than mounting apertures 414 and 416 as well as any aperture of aperture sets 121, 122, 125, 132 and 134 set forth in FIG. 4.

In yet another embodiment, edges of mounting member 420 of license mounting plate 400 may be designed with a different radius than set forth in FIGS. 2, 4 and 6.

While the invention has been described in terms of several embodiments, the invention should not limited to only those embodiments described, but can be practiced with modification and alteration within the spirit and scope of the invention.

What is claimed is:

1. A license mounting plate for adapting to a vehicle comprising:
a mounting member adapted for attachment to the vehicle;
a license holding member; and
at least two members to securely support a pair of turn signals.
